(19) United States
(12) Patent Application Publication
(10) Pub. No.: US 2013/0208320 A1
(43) Pub. Date: Aug. 15, 2013

(54) USING DEVICE, CONTROL METHOD, AND PROGRAM

(71) Applicants: Yasunobu Suzuki, Minato-ku (JP); Mitsuyoshi Kato, Chuo-ku (JP)

(72) Inventors: Yasunobu Suzuki, Minato-ku (JP); Mitsuyoshi Kato, Chuo-ku (JP)

(73) Assignees: ALTECH CO., LTD., Tokyo (JP); NEC EMBEDDED PRODUCTS, LTD., Tokyo (JP)

(21) Appl. No.: 13/818,877

(22) PCT Filed: Sep. 14, 2011
(86) PCT No.: PCT/JP2011/071005

§ 371 Date: Apr. 26, 2013

(30) Foreign Application Priority Data
Sep. 30, 2010 (JP) 2010-223229

(51) Int. Cl. G06K 15/00

(52) U.S. Cl. CPC G06K 15/4075
USPC 358/1.16

(57) ABSTRACT

A consumable product (200) can be detached from a using device (100), and includes a memory (201), and the memory (201) includes a first recording area that rewritably records a remaining amount of the consumable product (200), and includes a plurality of second recording areas for specifying a state of the remaining amount of the consumable product (200) recorded in the first recording area. The using device (100) of the present embodiment reads the remaining amount of the consumable product (200) recorded in the first recording area, determines whether or not the read remaining amount of the consumable product (200) is positioned in a range between the second recording area in a writing-prohibition state and the second recording area in a writable state, determines that the consumable product (200) is a genuine product when the remaining amount of the consumable product (200) is positioned in the range, and determines that the consumable product (200) is an illicit product when the remaining amount of the consumable product (200) is not positioned in the range.

### TECHNICAL FIELD

The present invention relates to a technique for preventing illicit use of a consumable product.

### BACKGROUND ART

Recently, consumable products have been reused in order to effectively use environmental resources.

Generally, the consumable product is processed to be reproduced in a genuine reproduction factory recommended by a manufacturer so that the reproduced consumable product can be reused. However, in the present situation, an illicit consumable products (non-regular product) that are not genuine consumable products (regular products) recommended by the manufacturer are distributed in the market.

The illicit products are manufactured of materials that are lower in quality than those of the genuine products. For example, when an illicit product is used in an image forming device, problems such as degradation in printing quality and malfunction of the image forming device are caused. Depending on conditions, the manufacturer that manufactured and sold the using device such as the image forming device possibly takes the responsibility, instead of a manufacturer that manufactured and sold the illicit product.

By taking such problems into consideration, concerning the image forming device, Patent Literature 1 (Japanese Patent No. 4273724) discloses a technique of prohibiting use of a pirated consumable product, or a consumable product that has been illicitly refilled with toner.

In Patent Literature 1, count data 60 for counting the number of printed sheets is stored in a storage area in an RFID sheet 33 without setting up a lock bit. The count data 60 is encoded to be stored, and when the count data 60 is read, algorithm of encoding is reversely followed to decode the count data 60. When the count data 60 stored in the RFID sheet 33 largely exceeds the printing-possible number of sheets, it is determined that toner has been illicitly resupplied, prohibiting the use. Thereby, a consumable product to which toner has been illicitly resupplied is prevented from being used. Meanwhile, when toner is properly resupplied, the count data 60 is set to be an initial value so that the count data 60 of the initial value can be stored in the storage area of the RFID sheet 33.

### PRIOR ART LITERATURE

### Patent Literature

[Patent Literature 1] Japanese Patent No. 4273724

### DISCLOSURE OF THE INVENTION

### Problem to be Solved by the Invention

In Patent Literature 1, the count data 60 for counting the number of printed sheets is encoded to be stored in the storage area of the RFID sheet 33. However, if the algorithm of the encoding is interpreted, the count data 60 can be easily rewritten.

If toner is illicitly resupplied, and the count data 60 can be rewritten, it becomes impossible to detect illicit toner resupply, and it becomes impossible to prevent illicit use of a consumable product.

In view of the above-described problem, the present invention has been made. An object of the present invention is to provide a using device, a control method, and a program that can prevent illicit rewriting of a remaining amount of a consumable product, without encoding, and can prevent illicit use of a consumable product.

### Means for Solving the Problem

In order to accomplish the above-described object, the present invention has the following feature.

<Using Device>

A using device of the present invention is a using device using a consumable product which is detachable to the using device, and includes a memory, the memory including a first recording area that rewritably records a remaining amount of the consumable product and a plurality of second recording areas for specifying a state of the remaining amount of the consumable product recorded in the first recording area, the using device comprising:

rewriting means for setting the second recording area to a writing-prohibition state from a writable state in accordance with the remaining amount of the consumable product recorded in the first recording area, and setting a state of the second recording areas such that the remaining amount of the consumable product recorded in the first recording area is positioned between the second recording area in a writing-prohibition state and the second recording area in a writable state; and

controlling means for reading the remaining amount of the consumable product recorded in the first recording area, determining whether or not the read remaining amount of the consumable product is positioned in a range between the second recording area in the writing-prohibition state and the second recording area in the writable state, determining that the consumable product is a genuine product when the remaining amount of the consumable product is positioned in the range, and determining that the consumable product is an illicit product when the remaining amount of the consumable product is not positioned in the range.

<Control Method>

A control method of the present invention is a control method performed by a using device that uses a consumable product, which is detachable to the using device, and includes a memory, the memory including a first recording area that rewritably records a remaining amount of the consumable product and a plurality of second recording areas for specifying a state of the remaining amount of the consumable product recorded in the first recording area, the control method comprises:

a rewriting step of setting, by the using device, the second recording area to a writing-prohibition state from a writable state in accordance with the remaining amount of the consumable product recorded in the first recording area, and setting a state of the second recording areas such that the remaining amount of the consumable product recorded in the first recording area is positioned between the second recording area in a writing-prohibition state and the second recording area in a writable state; and

a controlling step of reading, by the using device, the remaining amount of the consumable product recorded in the first recording area, determining whether or not the read remaining amount of the consumable product is positioned in a range between the second recording area in the writing-prohibition state and the second recording area in the writable state, determining that the consumable product is a genuine product when the remaining amount of the consumable product is positioned in the range, and determining that the consumable product is an illicit product when the remaining amount of the consumable product is not positioned in the range.

<Program>

A program of the present invention is a program causing a computer of a using device to perform a process, the using device using a consumable product, which is detachable to the using device, and includes a memory, the memory including a first recording area that rewritably records a remaining amount of the consumable product and a plurality of second recording areas for specifying a state of the remaining amount of the consumable product recorded in the first recording area, the program causes the computer to perform:

a rewriting process of setting the second recording area to a writing-prohibition state from a writable state in accordance with the remaining amount of the consumable product recorded in the first recording area, and setting a state of the second recording areas such that the remaining amount of the consumable product recorded in the first recording area is positioned between the second recording area in a writing-prohibition state and the second recording area in a writable state; and

a controlling process of reading the remaining amount of the consumable product recorded in the first recording area, determining whether or not the read remaining amount of the consumable product is positioned in a range between the second recording area in the writing-prohibition state and the second recording area in the writable state, determining that the consumable product is a genuine product when the remaining amount of the consumable product is positioned in the range, and determining that the consumable product is an illicit product when the remaining amount of the consumable product is not positioned in the range.

### Effects of the Invention

According to the present invention, illicit rewriting of a remaining amount of a consumable product can be prevented without encoding, and illicit use of a consumable product can be prevented.

### BRIEF DESCRIPTION OF DRAWINGS

FIG. 1 shows an image forming device 100 that is one example of a using device 100 according to the present embodiment;

FIG. 2 shows an example of data configuration of a RFID tag (memory) 201;

FIG. 3 shows data and lock flags recorded in the RFID tag (memory) 201 when an ink ribbon 200 is in mint condition;

FIG. 4 shows an example of updating a remaining ink amount in the RFID tag (memory) 201;

FIG. 5 shows an example of a process of updating the lock flag of the RFID tag (memory) 201;

FIG. 6 shows an example of information managed in the storage 102;

FIG. 7 shows an example of detecting illicit alteration of a remaining ink amount in RFID tag (memory) 201;

FIG. 8 shows a state of the RFID tag 201 after a film of the ink ribbon 200 is used by the 45 meters from mint condition; and

FIG. 9 shows a state of the RFID tag 201 after a film of the ink ribbon 200 is used by the 96 meters from mint condition.

### MODE FOR CARRYING OUT THE INVENTION

<Summary of Using Device 100 of Present Embodiment>

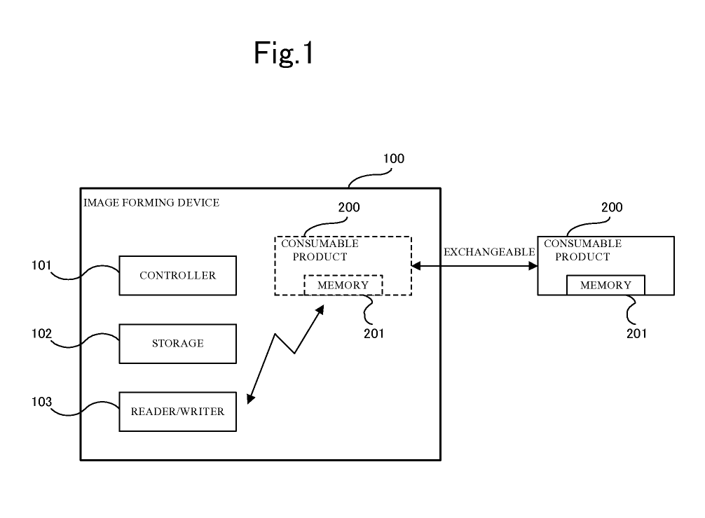

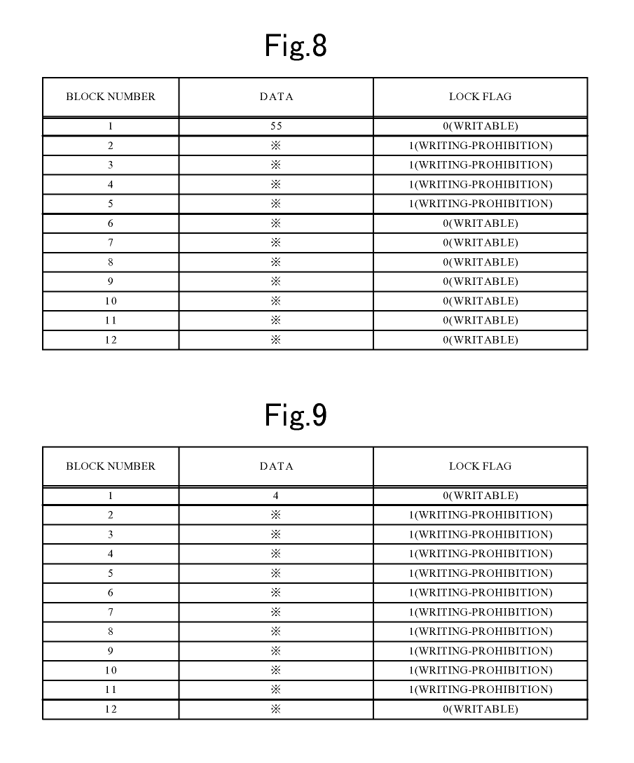

First, referring to FIG. 1 and FIG. 8, the summary of a using device 100 will be described. FIG. 1 illustrates an example of a configuration of an image forming device 100 that is one example of the using device 100 of the present embodiment. FIG. 8 illustrates a state in a memory 201 of a consumable product 200.

The using device 100 of the present embodiment is a using device that uses the consumable product 200. The consumable product 200 of the present embodiment can be detached from the using device 100. The consumable product 200 includes the memory 201. As illustrated in FIG. 8, the memory 201 includes a first recording area (block number 1) that rewritably records a remaining amount of the consumable product 200, and a plurality of second recording areas (block numbers 2 to 12) that specify a state of the remaining amount of the consumable product 200 recorded in the first recording area (block number 1).

As illustrated in FIG. 8, the using device 100 of the present embodiment sets the second recording areas (block numbers 2 to 12) to a writing-prohibition state from a rewritable state, in accordance with the remaining amount (55) of the consumable product 200 recorded in the first recording area (block number 1), and sets a state of the second recording areas (block numbers 2 to 12) such that the remaining amount (55) of the consumable product 200 recorded in the first recording area (block number 1) is positioned between the second recording area (block number 5) of the writing-prohibition state and the second recording area (block number 6) of the writable state. Then, the remaining amount (55) of the consumable product 200 recorded in the first recording area (block number 1) is read to determine whether or not the read remaining amount (55) of the consumable product 200 is positioned in a range between the second recording area (block number 5) of the writing-prohibition state and the second recording area (block number 6) of the writable state. When the remaining amount (55) of the consumable product 200 is positioned in the above-mentioned range, it is determined that the consumable product 200 is a genuine product. Meanwhile, when the remaining amount (55) of the consumable product 200 is not positioned in the above-mentioned range, it is determined that the consumable product 200 is an illicit product. Thereby, illicit rewriting of the remaining amount of the consumable product 200 can be prevented without encoding, and illicit use of the consumable product 200 can be prevented. In the following, the using device 100 of the present embodiment will be described in detail with reference to the accompanying drawings. The following will be described, taking the image forming device 100 as one example of the using device 100.

### First Embodiment

### Example of Configuration of Image Forming Device 100 of Present Embodiment

First, referring to FIG. 1, an example of a configuration of the image forming device 100 according to the present embodiment will be described.

The image forming device 100 of the present embodiment is a using device that uses the consumable product 200 containing ink, toner, or the like. The image forming device 100 is configured so as to include a controller 101, a storage 102, and a reader/writer 103.

The controller 101 controls the image forming device 100. The storage 102 stores various types of information required for using the image forming device 100. The reader/writer 103 records various types of information in the memory 201 provided in the consumable product 200, and reads the various types of information recorded in the memory 201. In the present embodiment, the description will be made, assuming the reader/writer 103 to be an RFID reader/writer.

The consumable product 200 contains toner, ink, or the like used when the image forming device 100 forms an image. The consumable product 200 is configured so as to include the memory 201. The memory 201 stores various types of information for managing the consumable product 200. In the present embodiment, the description will be made, assuming the memory 201 to be an RFID tag.

The image forming device 100 of the present embodiment is configured such that the consumable product 200 can be detached from the image forming device 100 to be replaced with another consumable product. When the consumable product 200 is normally set in the image forming device 100, wireless communication is performed between the RFID reader/writer 103 and the RFID tag 201 so that the RFID reader/writer 103 can read the information recorded in the RFID tag 201, and can record the information in the RFID tag 201.

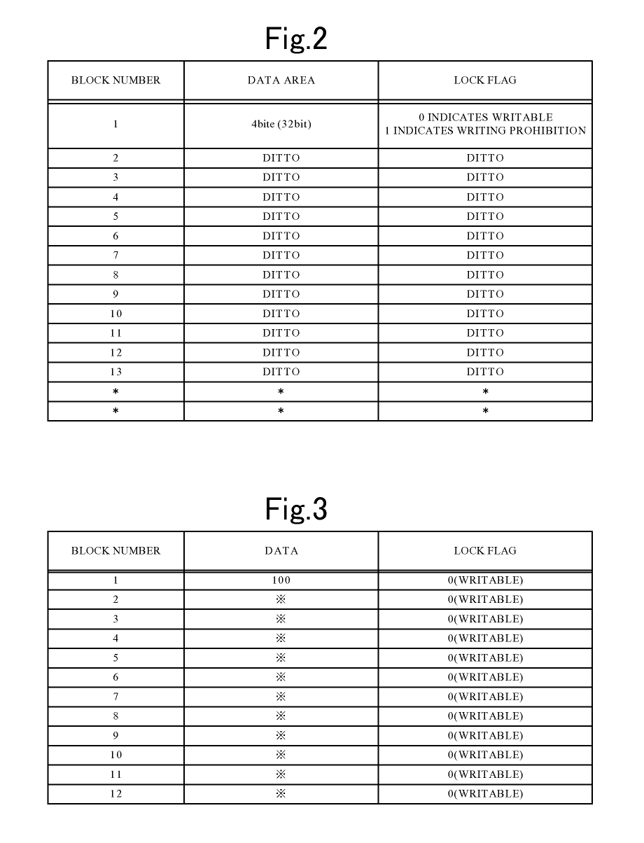

The RFID tag 201 is configured by memory blocks as illustrated in FIG. 2. In the memory blocks of FIG. 2, the block number is allocated to each of predetermined data areas (4 bytes, i.e., 32 bits in FIG. 2). Each block includes a lock flag. The lock flag indicates a state in which data can be written in the data area, or a state in which data writing in the data area is prohibited. For example, when the lock flag is 0, it is determined that the data area is in the state in which data can be written in the data area, and when the lock flag is 1, it is determined that the data area is in the state in which data writing in the data area is prohibited. If the lock flag is once made to indicate the state in which data writing in the data area is prohibited, the state cannot be returned to the state in which data can be written in the data area.

<Example of Processing Operation of Image Forming Device 100>

Next, processing operation of the image forming device 100 of the present embodiment will be described. The following description will be made, taking as an example the image forming device 100 that uses an ink ribbon as the consumable product 200. Known mechanism can be applied to the ink ribbon 200 and the image forming device 100 using the ink ribbon 200.

Remaining ink amount of the ink ribbon 200 in mint condition is recorded in the RFID tag 201. In the present embodiment, the description is made, using a length of a film of the ink ribbon 200 as the remaining ink amount of the ink ribbon 200. However, the remaining ink amount can be specified by various methods, and is not limited to a length of the film.

A length of the film of the ink ribbon 200 in mint condition is assumed to be 100 meters. In this case, the numeral “100” indicating that the remaining ink amount is 100 meters is recorded in the data area of the block number 1 of the RFID tag 201. FIG. 3 illustrates data recorded in the RFID tag 201, and states of the lock flags, when the ink ribbon 200 is in mint condition. FIG. 3 illustrates an example in which a range from the block number 1 to the block number 12 is used.

When the ink ribbon 200 is in mint condition, as illustrated in FIG. 3, the numeral “100” is recorded as an initial value of the remaining ink amount in the data area of the block number 1. All of the lock flags of the block numbers 1 to 12 are in the writable state.

<Example of Updating Remaining Ink Amount in RFID Tag 201>

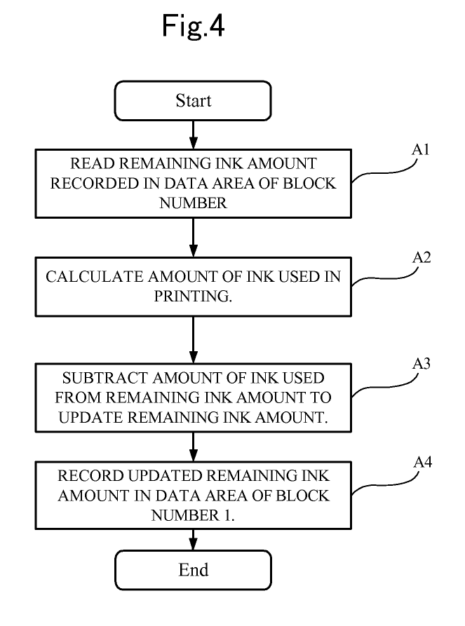

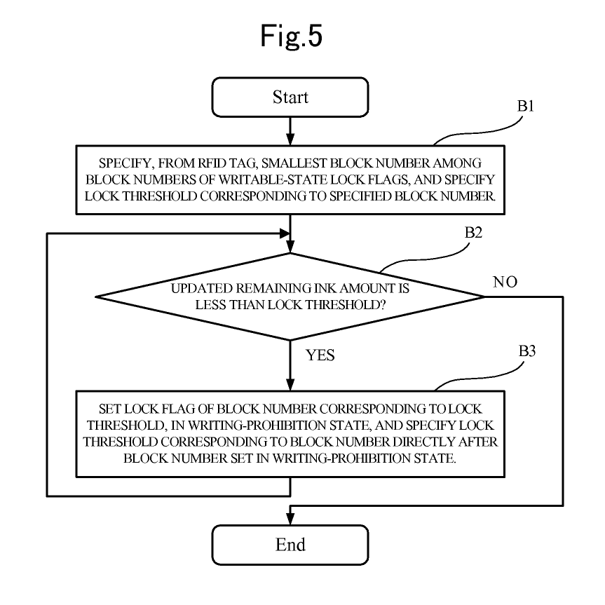

When the image forming device 100 starts printing operation by using the ink ribbon 200 including the RFID tag 201, the image forming device 100 starts processing operation shown in FIG. 4 to update the remaining ink amount recorded in the RFID tag 201.

The controller 101 of the image forming device 100 reads the remaining ink amount recorded in the data area of the block number 1 of the RFID tag 201 (step A1). Next, the controller 101 calculates a used amount of ink in the ink ribbon 200, having been used in the printing operation (step A2). The used amount of ink can be obtained by calculating a length of the film of the ink ribbon, which has been used in the printing operation.

Subsequently, the controller 101 subtracts the calculated, used amount of ink from the remaining ink amount read from the data area of the block number 1 of the RFID tag 201 to update the remaining ink amount of the ink ribbon 200 (step A3). The controller 101 then records the updated remaining ink amount in the data area of the block number 1 of the RFID tag 201 (step A4). Thereby, each time the printing operation is performed, the controller 101 can update the remaining ink amount recorded in the data area of the block number 1 of the RFID tag 201, on the basis of the used amount of ink of the ink ribbon 200, which has been used in the printing operation.

Since the RFID tag is a nonvolatile memory, the data is not erased, and is maintained as it is if the image forming device 100 is made powered off. Accordingly, when the image forming device 100 is made powered on, the controller 101 can read the data recorded in the RFID tag 201.

<Example of Process of Updating Lock Flag of RFID Tag 201>

Each time the controller 101 updates the remaining ink amount recorded in the data area of the block number 1 of the RFID tag 201, the controller 101 starts processing operation shown in FIG. 5 to set the lock flag of the block number to be the writing-prohibiting state, the block number corresponding to the remaining ink amount. Thereby, the controller 101 updates the lock flag.

The controller 101 refers to the RFID tag 201 to specify, from the RFID tag 201, the block number (except the block number 1) that is the smallest number among the block numbers of the writable-state lock flags (step B1). Then, the controller 101 specifies the lock threshold corresponding to the specified block number (step B1).

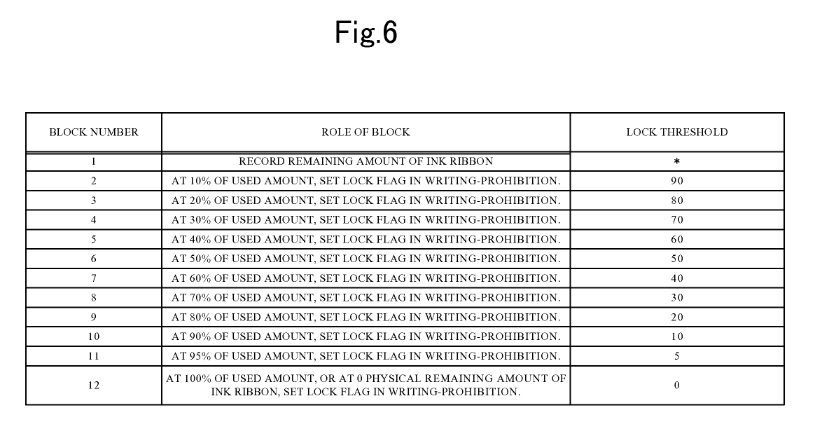

The lock threshold is a threshold for determining whether or not to make the lock flag of the RFID tag 201 to the writing-prohibition state. As shown in FIG. 6, the block number, the role of the block number, and the lock threshold are associated with one another to be managed in the storage 102 in the image forming device 100. The block numbers that are shown in FIG. 6 and that are managed in the storage 102 uniquely correspond to the block numbers that are shown in FIG. 3 and that constitute the memory blocks of the RFID tag 201. The role of the block number is provided for understanding the role of the block number. For example, the block number 1 has the role of recording the remaining ink amount of the ink ribbon 200. The block number 2 has the role of setting the writing-prohibition state lock flag when the used amount of ink becomes 10%. The block number 3 has the role of setting the writing-prohibition state lock flag when the used amount of ink becomes 20%. The block number 12 has the role of setting the writing-prohibition state lock flag when the used amount of ink becomes 100%, or when physical remaining ink amount of the ink ribbon 200 becomes zero. The above-described length of the film can be used to calculate the used amount of ink of the ink ribbon 200. A fact that the physical remaining ink amount of the ink ribbon 200 becomes zero can be detected by using a rotary encoder rotating together with a shaft of the ink ribbon 200, and a sensor counting output of the rotary encoder, and by detecting the stop of rotation of the shaft on the basis of a counted value of the rotary encoder.

The controller 101 refers to the information that is shown in FIG. 6 and that is managed in the storage 102 to specify, from the storage 102, the lock threshold corresponding to the block number specified from the RFID tag 201.

The controller 101 compares the lock threshold specified from the storage 102, with the updated remaining ink amount to determine whether or not the updated remaining ink amount is less than the lock threshold (step B2). When the updated remaining ink amount is less than the lock threshold (yes at step B2), the controller 101 sets the lock flag of the block number corresponding to the concerned lock threshold, to the writing-prohibition state, and specifies, from the storage 102, the lock threshold corresponding to the block number directly after the block number currently set in the writing-prohibition state (step B3). Then, the controller 101 determine whether or not the updated remaining ink amount is less than the lock threshold (step B2), again.

On the other hand, when the updated remaining ink amount is not less than the lock threshold (no at step B2), the process is terminated (end).

For example, it is assumed that the length of the film of the ink ribbon 200 in mint condition is 100 meters, and that the film of the ink ribbon 200 was used by 10 meters in the printing operation. In this case, the controller 101 performs the processing operation shown in FIG. 4 to update the remaining ink amount to the numeral “90” from the numeral “100” (100−10=90), the remaining ink amount being recorded in the data area of the block number 1. Further, the controller 101 performs the processing operation shown in FIG. 5 to compare the updated remaining ink amount (90) with the lock threshold (90) corresponding to the block number 2 that is the smallest number among the block numbers that are writable-state lock flags (step B2). The remaining ink amount (90) is equal to or smaller than the lock threshold (90) (yes at step B2), so that the controller 101 sets the lock flag of the block number 2 corresponding to the lock threshold (90), to the writing-prohibition state (step B3). Furthermore, the controller 101 compares the updated remaining ink amount (90) with the lock threshold (80) corresponding to the block number 3 directly after the block number 2 for which the lock flag is currently set in the writing-prohibition state (step B2). The remaining ink amount (90) is not equal to or not smaller than the lock threshold (80) (no at step B2), so that the process is terminated (end). Thereby, the lock flag of the block number 2 is set to the writing-prohibition state.

Further, it is assumed that the film of the ink ribbon 200 was used by 25 meters in the printing operation. In this case, the controller 101 performs the processing operation shown in FIG. 4 to update the remaining ink amount to the numeral “65” from the numeral “90” (90−25=65), the remaining ink amount being recorded in the data area of the block number 1. Further, the controller 101 performs the processing operation shown in FIG. 5 to compare the updated remaining ink amount (65) with the lock threshold (80) corresponding to the block number 3 that is the smallest number among the block numbers that are writable-state lock flags (step B2). The remaining ink amount (65) is equal to or smaller than the lock threshold (80) (yes at step B2), so that the controller 101 sets the lock flag of the block number 3 corresponding to the lock threshold (80), to the writing-prohibition state (step B3). Furthermore, the controller 101 compares the updated remaining ink amount (65) with the lock threshold (70) corresponding to the block number 4 directly after the block number 3 for which the lock flag is currently set in the writing-prohibition state (step B2). The remaining ink amount (65) is equal to or smaller than the lock threshold (70) (yes at step B2), so that the controller 101 sets the lock flag of the block number 4 corresponding to the lock threshold (70), to the writing-prohibition state (step B3). Furthermore, the controller 101 compares the updated remaining ink amount (65) with the lock threshold (60) corresponding to the block number 5 directly after the block number 4 for which the lock flag is currently set in the writing-prohibition state (step B2). The remaining ink amount (65) is not equal to or not smaller than the lock threshold (60) (no at step B2), so that the process is terminated (end). Thereby, the lock flags of the block numbers 3 and 4 are set to the writing-prohibition state.

<Example of Detecting Illicit Alteration of Remaining Ink Amount in RFID Tag 201>

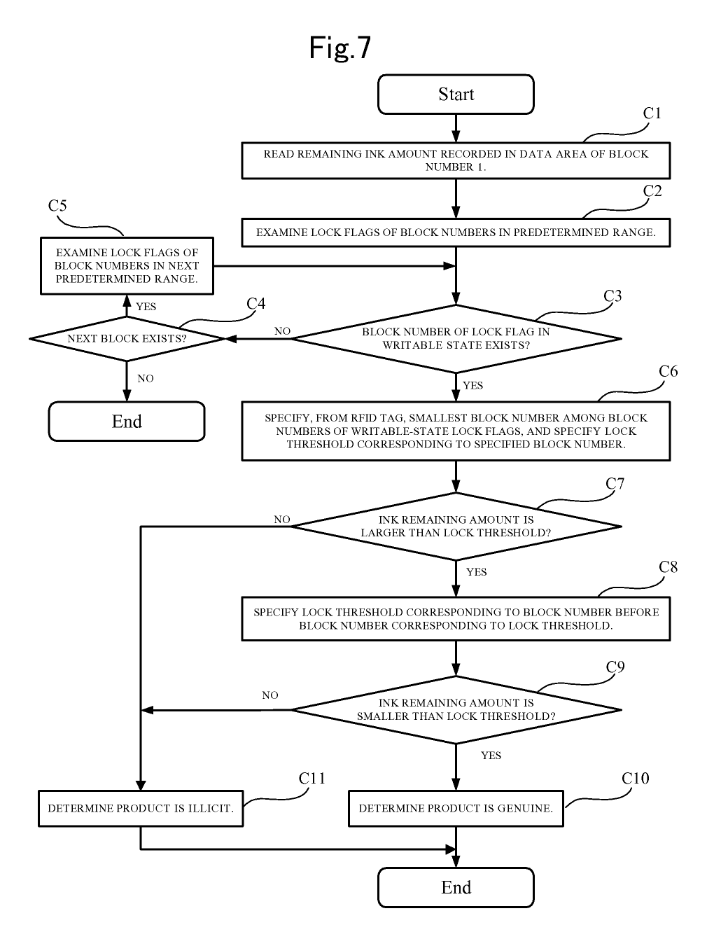

When the controller 101 detects a predetermined condition, such as action of powering on the image forming device 100 and replacement of the consumable product, in which replacement of the ink ribbon is possibly performed, the controller 101 performs processing operation shown in FIG. 7 to determine whether or not the remaining ink amount recorded in the data area of the block number 1 in the RFID tag 201 of the ink ribbon 200 is illicitly altered.

When the controller 101 detects the predetermined condition, such as action of powering on the image forming device 100, and replacement of the consumable product, in which replacement of the ink ribbon 200 is possibly performed, the controller 101 reads the remaining ink amount recorded in the data area of the block number 1 in the RFID tag 201 of the ink ribbon 200 (step C1).

The controller 101 examines the lock flags of the block numbers in a predetermined range in the RFID tag 201 (step C2) to determine whether or not the block number that is the writable state lock flag exists (step C3). The predetermined range can be arbitrarily set and changed. When the block number that is the writable-state lock flag does not exist (no at step C3), the controller 101 determines whether or not the next block number exists (step C4). When the next block exists (yes at step C4), the controller 101 examines the lock flags of the block numbers in a next predetermined range (step C5). On the other hand, when the next block does not exist (no at step C4), the process is terminated (end).

When the controller 101 examines the lock flags of the block numbers in the predetermined range at the step C2 or C5, if the block number of which state is supposed to be not set in the writing-prohibition state has been set in the writing-prohibition state, for example, if any one or more blocks have been set in the writing-prohibition state in the situation that the lock flags of any block numbers are supposed to be not set in the writing-prohibition state, the controller 101 determines that the remaining ink amount has been illicitly altered, and determines that the ink ribbon 200 is an illicit product.

When the block number that is the writable-state lock flag exists (yes at step C3), the controller 101 specifies, from the RFID tag 201, the smallest block number (except the block number 1) among the block numbers that are writable-state lock flags. Then, the controller 101 specifies, from the storage 102, the lock threshold corresponding to the specified block number (step C6).

The controller 101 compares the lock threshold specified from the storage 102 with the remaining ink amount to determine whether or not the remaining ink amount is larger than the lock threshold (step C7). When the remaining ink amount is larger than the lock threshold (yes at step C7), the controller 101 specifies, from the storage 102, the lock threshold corresponding to the block number before the block number corresponding to the lock threshold used at the step C7 (step C8), to compare the lock threshold specified from the storage 102 with the remaining ink amount. Thereby, the controller 101 determines whether or not the remaining ink amount is smaller than the lock threshold (step C9). When the remaining ink amount is smaller than the lock threshold (yes at step C9), the controller 101 determines that the remaining ink amount is positioned between the block number that is the writable-state lock flag and the block number that is the writing-prohibition state lock flag, and determines that the remaining ink amount is not illicitly altered (the ink ribbon is a genuine product) (step C 10). Then, the process is terminated (end).

On the other hand, when the controller 101 determines that the remaining ink amount is smaller than the lock threshold at the step C7, or when the controller 101 determines that the remaining ink amount is larger than the lock threshold at the step C9, the controller 101 determines that the remaining ink amount is not positioned between the block number that is the writable-state lock flag and the block number that is the writing-prohibition lock flag, and determines that the remaining ink amount is illicitly altered (the ink ribbon is an illicit product) (step C11). Then, the process is terminated (end).

For example, when the ink ribbon 200 is in mint condition, the lock flags of the block numbers 2 to 12 are in the writable state as shown in FIG. 3. In this case, the controller 101 compares the remaining ink amount (100) read from the data area 1 of the block number 1, with the lock threshold (90) corresponding to the block number 2 that is the smallest number among the block numbers (except the block number 1) that are the writable-state lock flags. In this comparison, the remaining ink amount (100) is larger than the lock threshold (90), so that the controller 101 specifies the lock threshold corresponding to the block number 1 before the block number 2 corresponding to the threshold (90). However, the block number 1 is provided for recording the remaining ink amount. For this reason, in this case, the controller 101 determines that the ink ribbon 200 is a genuine product.

Next, from the state shown in FIG. 3, the printing operation of the image forming device 100 is repeated. FIG. 8 shows a state of the RFID tag 201 after the film of the ink ribbon 200 was used by the 45 meters from mint condition.

In the state as shown in FIG. 8, when the controller 101 detests the predetermined condition that the ink ribbon 200 is possibly replaced, the controller 101 reads the remaining ink amount (55) from the data area of the block number 1 (step C1), and examines the flock flags of the block numbers 2 to 12 in the predetermined range (step C2).

Since the block numbers 2 to 5 are successively in the writing-prohibition state, and the block number 6 to 12 are successively in the writable state (yes at step C3), the controller 101 compares the remaining ink amount (55) with the lock threshold (50) corresponding to the block number 6 that is the smallest number among the block numbers 6 to 12 in the writable state (steps C6 and C7). The remaining ink amount (55) is larger than the lock threshold (50) (remaining amount 55>lock threshold 50) (yes at step C7). Accordingly, the controller 101 specifies the lock threshold (60) corresponding to the block number 5 directly before the block number 6 corresponding to the threshold (50) (step C8). Then, the controller 101 compares the remaining ink amount (55) with the lock threshold (60) corresponding to the block number 5 directly before the block number 6 (step C9). In this case, the remaining ink amount (55) is smaller than the threshold (60) (yes at step C9), so that the controller 101 determines that the remaining ink amount is positioned between the block number 6 that is the writable-state lock flag and the block number 5 that is the writing-prohibition state lock flag, and determines that the remaining ink amount (55) of the block number 1 has not been illicitly altered (the ink ribbon 200 is a genuine product) (step C10).

It is assumed that the remaining ink amount of the block number 1 has been illicitly altered to be the value (100) of the initial state. In this case, the remaining ink amount (100) of the block number 1 is larger than the threshold (50) corresponding to the block number 6 (remaining ink amount 100>lock threshold 50) (yes at step C7). Accordingly, the controller 101 compares the remaining ink amount (100) with the lock threshold (60) corresponding to the block number 5 directly before the block number 6 (step C9). In this case, the remaining ink amount (100) is larger than the lock threshold (60) (no at step C9), so that the controller 101 determines that the remaining ink amount (100) is not positioned between the block number 6 that is the writable-state lock flag and the block number 5 that is the writing-prohibition lock flag, and determines that the remaining ink amount (100) has been illicitly altered (the ink ribbon 200 is an illicit product) (step C11). If the controller 101 determines that the remaining ink amount has been illicitly altered (the ink ribbon 200 is an illicit product), the controller 101 makes notification of an error, or notifies that the product is an illicit one, for example to perform control so as not to execute printing operation.

Thus, if the remaining ink amount recorded in the data area of the block number 1 has been largely altered in an illicit manner, the illicitly altered remaining ink amount is not positioned between the block number that is the writable state lock flag and the block number that is the writing-prohibition lock flag, so that the controller 101 detects that the product is an illicit one. Thereby, illicit alteration of the remaining ink amount can be suppressed. By making intervals of the lock thresholds finer, it can be accurately detected whether or not the remaining ink amount has been illicitly altered.

FIG. 9 shows a state of the RFID tag 201 after the printing operation of the image forming device 100 is repeated from the state shown in FIG. 8, and the film of the ink ribbon 200 is thereby used by 96 meters from mint condition. In this case, the lock flags of the block numbers 2 to 11 have been set to the writing-prohibition state, and the remaining ink amount of the block number 1 is made to be 4 (100−96). Since the remaining ink amount of the ink ribbon 200 in the initial state is 100 meters, the net remaining ink amount is 4 meters.

It is assumed that, after the state of the RFID tag 201 becomes the state shown in FIG. 9, the RFID tag 201 of the ink ribbon 200 is detached to be attached to an illicit ink ribbon without illicitly altering the remaining ink amount (4) in the block number 1 of the RFID tag 201. If the thus-detached-and-attached RFID tag is used, even if the controller 101 performs the processing operation shown in FIG. 7. the controller 101 does not determine that the product is an illicit one since the remaining ink amount (4) in the block number 1 has not been illicitly altered. Accordingly, the illicit product can be used as it is in the image forming device 100.

However, when the illicit product is consumed by 4 meters, the controller 101 performs the processing operation shown in FIG. 4 to update the remaining ink amount in the data area of the block number 1 to be 0. Accordingly, the controller 101 performs the processing operation shown in FIG. 5 to set the lock flag of the block number 12 to the writing-prohibition state. In this case, the controller 101 presumes that the ink ribbon 200 is consumed to the end to stop the printing operation. As a result, use of the illicit product can be suppressed to the minimum even if the RFID tag 201 is detached from the genuine ink ribbon 200, and is then attached to the illicit product to be used.

<Effect and Advantage of Image Forming Device 100 of Embodiment>

Thus, the image forming device 100 records the remaining ink amount of the ink ribbon 200 in the RFID tag 201 to manage the remaining ink amount, and each time the image forming device 100 updates the remaining ink amount recorded in the RFID tag 201, the image forming device 100 sets one or more lock flags of the block numbers up to the lock flag corresponding to the updated remaining ink amount to indicate the writing-prohibition state from the writable state. Then, when the controller 101 detects the predetermined condition that the ink ribbon 200 is possibly replaced, the controller 101 compares the remaining ink amount recorded in the RFID tag 201, with the lock flag of each block number of the RFID tag 201. According to a result of this comparison, when the remaining ink amount is positioned between the block number that is the writing-prohibition state lock flag and the block number that is the writable state lock flag, the controller 101 determines that the ink ribbon 200 is a genuine product. On the other hand, when the remaining ink amount is not positioned between the block number that is the writing-prohibition state lock flag and the block number that is the writable state lock flag, the controller 101 determines that the ink ribbon 200 is an illicit product. Thereby, false rewriting of the remaining ink amount of the ink ribbon 200 can be prevented, and illicit use of the ink ribbon 200 can be prevented.

The ink ribbon 200 used in the image forming device 100 is designed so as to optimize printing quality and so as not to cause trouble in the image forming device 100. However, in the case of the ink ribbon other than the product recommended by the manufacturer, a material of low quality is used, so that printing quality may be degraded, and trouble may be caused in the image forming device 100, for example. The image forming device 100 of the present embodiment uses the RFID tag 201 provided in the ink ribbon 200 to manage the remaining ink amount of the ink ribbon 200, and sets the lock flag from the writable state to the writing-prohibition state, in accordance with the remaining ink amount. Thereby, illicit use of the ink ribbon 200 can be prevented as much as possible to suppress occurrence of the above-described problems.

In the above-described processing operation as shown in FIG. 3, the net remaining amount (100) of the full ink ribbon 200 is recorded as the initial value in the data area of the block number 1. However, in fact, the net remaining amount (100) is uneven due to manufacturing factors, and an error is generated when the used amount of ink ribbon 200 is calculated. For this reason, preferably, such error generation is taken into consideration to set the initial value to be a value (at the level enabling the unevenness and error to be eased) that is a little larger than the net remaining amount (100), and the thus-set initial value is recorded.

When the initial value to be recorded in the data area of the block number 1 is set to be a value a little larger than the net remaining amount (100) of the ink ribbon 200, and the set initial value is recorded, the remaining ink amount of the ink ribbon 200 physically runs out before the remaining ink amount recorded in the data area becomes zero. For this reason, preferably, the image forming device 100 includes a mechanism that detects the remaining ink amount of the ink ribbon 200 physically runs out. For example, a rotary encoder that rotates together with the shaft of the ink ribbon 200, and a sensor that counts output of the rotary encoder are used to detect stop of rotation of the shaft on the basis of the counted value of the output of the rotary encoder. Thereby, it can be detected that the remaining ink amount of the ink ribbon 200 physically runs out.

### Second Embodiment

Next, a second embodiment will be described.

In the first embodiment, it is difficult to prevent the case in which information recorded in the RFID tag 201 is copied to be recorded in another RFID tag, and the RFID tag containing the copied information is attached to an illicit ink ribbon to be used. In other words, it is difficult to prevent imitating of the RFID tag 201. For this reason, in the present embodiment, identification information that can uniquely identify the RFID tag 201 is used to prevent the RFID tag 201 to be imitated.

For example, a unique ID that can uniquely identify a chip is written in the IC chip of the RFID tag 201. The manufacturer of the IC chips guarantees that the unique ID does not overlap any other IDs in the world. The unique ID is written in the RFID tag 201 in a state where the ID cannot be rewritten.

In the present embodiment, the unique ID, and predetermined arithmetic algorithm are used to generate the identification information corresponding to the unique ID. The identification information is also generated so as not to overlap any other identification information, and so as to correspond to the unique ID. The generated identification information is written in the RFID tag 201 when the ink ribbon is manufactured.

Then, when the consumable product 200 is correctly set in the image forming device 100, the controller 101 reads the unique ID and the identification information from the RFID tag 201. The controller 101 uses the read unique ID and the predetermined arithmetic algorithm used at the time of manufacturing the ink ribbon, to generate the identification information corresponding to the unique ID. When the generated identification number matches the identification information read from the RFID tag 201, the controller 101 determines that the consumable product is a genuine one. On the other hand, when the generated identification number does not match the identification information read from the RFID tag 201, the controller 101 determines that the consumable product is an illicit one.

Thereby, even if the information written in the RFID tag 201 is copied into the different RFID tag, imitating of the RFID tag 201 can be prevented since the identification information written in the RFID tag 201 cannot be calculated from unique ID of the different RFID tag. Thereby, imitating of the RFID tag 201 can be prevented.

<Effect and Advantage of Image Forming Device 100 of Present Embodiment>

Thus, the image forming device 100 of the present embodiment stores in the RFID tag 201 the unique identification information calculated on the basis of the unique ID that uniquely identifies the RFID tag 201. Then, the image forming device 100 reads the unique ID and the identification information from the RFID tag 201, and calculate the identification information on the basis of the read unique ID and the predetermined algorithm. When the calculated identification information matches the read identification information described above, the image forming device 100 determines that the product is a genuine one, and when the calculated identification information does not match the read identification information, the image forming device 100 determines that the product is an illicit one. Thereby, imitating of the RFID tag 201 can be prevented.

The above-described embodiments are preferred embodiments of the present invention, and do not limit the scope of the present invention to the matters of the embodiments.

The present invention can be embodied by making various modifications within the scope that does not depart from the gist of the present invention.

For example, the image forming device 100 of the above-described embodiments is described using an example of the ink ribbon. However, the image forming device 100 of the above-described embodiments is not limited to the device using the ink ribbon, and can perform the same process in the case of using toner, ink jet or the like. A method of calculating a used amount or a remaining amount of the consumable product changes depending on a type of the consumable product 200. Accordingly, a calculating method of a used amount or a remaining amount depending on the type of the consumable product is used. Since the calculating method of a used amount or a remaining amount of the consumable product 200 is known, various known methods can be used.

The control operation of each device constituting the image forming device 100 of the above-described present embodiments can be performed by using hardware, software, or the combined configuration thereof.

When the process is performed by using the software, a program that records a process sequence is installed in a memory in a computer to be executed, the computer being incorporated in dedicated hardware. Alternatively, the program is installed in a general-purpose computer that can perform various processes so that the computer can execute the program.

For example, the program can be recorded in advance in a storage medium such as a hard disk and a ROM (read only memory). Alternatively, the program can be temporarily or permanently held (stored) in a removable recording medium. Such a removable recording medium can be provided as what is called package software. Examples of the removable recording medium are a floppy (registered trade mark) disk, a CD-ROM (compact disk read only memory), an MO (magneto optical) disk, a DVD (digital versatile disk), a magnetic disk, a semiconductor memory, and the like.

The program may be installed in the computer from the removable disk as described above. Alternatively, the program may be transferred to the computer from a download site by radio communication. Alternatively, the program may be transferred to the computer via a network by wire communication.

The image forming device 100 of the present embodiments can be configured to perform the process steps in accordance with the processing operation described in the above-mentioned embodiments, in time order, or can be configured to perform the process steps in parallel or individually depending on necessity or depending on processing ability of the device that performs the process.

In the above-described embodiment, the description was made by using the image forming device 100 as an example. However, the technical idea of the present embodiments can be applied to any using device 100 that has a function of calculating a used amount and a remaining amount of the consumable product 200. For example, the technical idea can be applied to the consumable product such as mineral water and a fuel cell, as well. A used amount and a remaining amount of these consumable products can be measured, so that the technical idea of the present invention can be applied to these consumable products.

This application claims a right of priority that is based on Japanese Patent Application No. 2010-223229, filed on Sep. 30, 2010, and the disclosure of the above Japanese Patent Application is incorporated herein in its entirety.

### DESCRIPTION OF REFERENCE NUMERALS

100 Image forming device (using device)
101 Controller
102 Storage
103 Reader/writer (RFID reader/writer)
200 Consumable product (ink ribbon)
201 Memory (RFID tag)

1. A using device using a consumable product which is detachable to the using device, the consumable product includes a memory, the memory including a first recording area that rewritably records a remaining amount of the consumable product and a plurality of second recording areas for specifying a state of the remaining amount of the consumable product recorded in the first recording area, the using device comprising:
rewriter for setting the second recording area to a writing-prohibition state from a writable state in accordance with the remaining amount of the consumable product recorded in the first recording area, and setting a state of the second recording areas such that the remaining amount of the consumable product recorded in the first recording area is positioned between the second recording area in a writing-prohibition state and the second recording area in a writable state; and
controller for reading the remaining amount of the consumable product recorded in the first recording area, determining whether or not the read remaining amount of the consumable product is positioned in a range between the second recording area in the writing-prohibition state and the second recording area in the writable state, determining that the consumable product is a genuine product when the remaining amount of the consumable product is positioned in the range, and determining that the consumable product is an illicit product when the remaining amount of the consumable product is not positioned in the range.

2. The using device according to claim 1, wherein each time the remaining amount of the consumable product recorded in the first recording area is updated, the rewriter set the second recording area to the writing-prohibition state from the writable state, in accordance with the remaining amount of the consumable product.

3. The using device according to claim 2, further comprising
calculator for calculating a used amount of the consumable product that the using device has used,
wherein the rewriter records a subtracted value as the remaining amount of the consumable product in the first recording area, the subtracted value being obtained by subtracting the used amount of the consumable product calculated by the calculator, from the remaining amount of the consumable product recorded in the first recording area to update the remaining amount of the consumable product.

4. The using device according to claim 1, wherein when the rewriter sets all of the second recording areas for specifying a state of the remaining amount of the consumable product, to the writing-prohibition state from the writable state in accordance with the remaining amount of the consumable product recorded in the first recording area, the rewriter stops use of the consumable product.

5. The using device according to claim 1, wherein consecutive numbers are assigned to the second recording areas, respectively,
wherein the using device comprises manager for managing thresholds corresponding to the numbers of the second recording areas, respectively,
wherein the controller comprises:
first comparator for specifying the second recording area which is in the rewritable state and of which number is the smallest among the second recording areas in the rewritable state, and comparing the remaining amount of the consumable product with the threshold corresponding to the number of the specified second recording area; and
second comparator for comparing the remaining amount of the consumable product with the threshold corresponding to the number that is assigned to the second recording area in a writing-prohibition state and that is directly before the number of the specified second recording area when the remaining amount of the consumable product is larger than the threshold according to a comparison result by the first comparator,
wherein the remaining amount of the consumable product is smaller than the threshold according to a comparison result by the first comparator, or when the remaining amount of the consumable product is larger than the threshold according to a comparison result by the second comparator, the controller determines that the consumable product is an illicit product, and
wherein when the remaining amount of the consumable product is smaller than the threshold according to a comparison result by the second comparator, the controller determines that the consumable product is a genuine product.

6. A control method performed by a using device that uses a consumable product, which is detachable to the using device, the consumable product includes a memory, the memory including a first recording area that rewritably records a remaining amount of the consumable product and a plurality of second recording areas for specifying a state of the remaining amount of the consumable product recorded in the first recording area, the control method comprises:
a rewriting step of setting, by the using device, the second recording area to a writing-prohibition state from a writable state in accordance with the remaining amount of the consumable product recorded in the first recording area, and setting a state of the second recording areas such that the remaining amount of the consumable product recorded in the first recording area is positioned between the second recording area in a writing-prohibition state and the second recording area in a writable state; and
a controlling step of reading, by the using device, the remaining amount of the consumable product recorded in the first recording area, determining whether or not the read remaining amount of the consumable product is positioned in a range between the second recording area in the writing-prohibition state and the second recording area in the writable state, determining that the consumable product is a genuine product when the remaining amount of the consumable product is positioned in the range, and determining that the consumable product is an illicit product when the remaining amount of the consumable product is not positioned in the range.

7. A recording medium on which a program is recorded that causes a computer of a using device to perform a process, the using device using a consumable product, which is detachable to the using device, the consumable product includes a memory, the memory including a first recording area that rewritably records a remaining amount of the consumable product and a plurality of second recording areas for specifying a state of the remaining amount of the consumable product recorded in the first recording area, the recording medium on which the program is recorded that causes the computer to perform:
a rewriting process of setting the second recording area to a writing-prohibition state from a writable state in accordance with the remaining amount of the consumable product recorded in the first recording area, and setting a state of the second recording areas such that the remaining amount of the consumable product recorded in the first recording area is positioned between the second recording area in a writing-prohibition state and the second recording area in a writable state; and
a controlling process of reading the remaining amount of the consumable product recorded in the first recording area, determining whether or not the read remaining amount of the consumable product is positioned in a range between the second recording area in the writing-prohibition state and the second recording area in the writable state, determining that the consumable product is a genuine product when the remaining amount of the consumable product is positioned in the range, and determining that the consumable product is an illicit product when the remaining amount of the consumable product is not positioned in the range.
